(19) United States
(12) Patent Application Publication
(10) Pub. No.: US 2022/0325720 A1
(43) Pub. Date: Oct. 13, 2022

(54) COMPRESSOR SHROUDED IMPELLER ARRANGEMENT

(71) Applicant: DANFOSS A/S, NORDBORG (DK)

(72) Inventors: Tianlei Li, Tallahassee, FL (US); Lin Xiang Sun, Tallahassee, FL (US); Kevin Lohman, Tallahassee, FL (US)

(21) Appl. No.: 17/640,550

(22) PCT Filed: Dec. 7, 2020
(86) PCT No.: PCT/US20/63562

§ 371 Date: Mar. 4, 2022

Related U.S. Application Data
(60) Provisional application No. 62/945,536, filed on Dec. 9, 2019.

(51) Int. Cl. F04D 29/28; F04D 29/02; F25B 1/053

(52) U.S. Cl. CPC F04D 29/284; F04D 29/023; F25B 1/053; F05D 2230/23

(57) ABSTRACT

A refrigerant compressor according to an exemplary aspect of the present disclosure includes, among other things, an impeller configured to rotate about an axis, and a shroud. The impeller has a plurality of blades. The shroud is secured to the impeller with an adhesive at tips of the plurality of blades.

### PRIORITY CLAIM

This application claims the benefit of U.S. Provisional Application No. 62/945,536, filed on Dec. 9, 2019.

### TECHNICAL FIELD

This disclosure relates to a shrouded impeller for a compressor, and a method of joining a shroud to an impeller. The compressor is used in a heating, ventilation, and air conditioning (HVAC) chiller system, for example.

### BACKGROUND

Refrigerant compressors are used to circulate refrigerant in a chiller via a refrigerant loop. Refrigerant loops are known to include a condenser, an expansion device, and an evaporator. The compressor compresses the fluid, which then travels to a condenser, which in turn cools and condenses the fluid. The refrigerant then goes to an expansion device, which decreases the pressure of the fluid, and to the evaporator, where the fluid is vaporized, completing a refrigeration cycle.

Many refrigerant compressors are centrifugal compressors and have an electric motor that drives at least one impeller to compress refrigerant. Fluid flows into the impeller in an axial direction, and is expelled radially from the impeller. The fluid is then directed downstream for use in the chiller system.

### SUMMARY

A refrigerant compressor according to an exemplary aspect of the present disclosure includes, among other things, an impeller configured to rotate about an axis, and a shroud. The impeller has a plurality of blades. The shroud is secured to the impeller with an adhesive at tips of the plurality of blades.

In a further embodiment, the adhesive cures at a low temperature.

In a further embodiment, the impeller and shroud are secured to one another without the use of welding or brazing.

In a further embodiment, the adhesive permanently secures the shroud to the impeller.

In a further embodiment, the impeller and the shroud are configured to rotate together on a shaft.

In a further embodiment, a motor drives the impeller via the shaft.

In a further embodiment, the impeller, shroud, and motor are arranged in a housing.

In a further embodiment, the shroud is formed from a shroud material having a lower specific stiffness than an impeller material.

In a further embodiment, the shroud is formed from a shroud material that has a first coefficient of thermal expansion and the impeller is formed from an impeller material that has a second coefficient of thermal expansion, the second coefficient of thermal expansion is different from the first coefficient of thermal expansion.

In a further embodiment, the adhesive has a third coefficient of thermal expansion that is higher than the first and second coefficients of thermal expansion.

In a further embodiment, the shroud and the impeller are both formed from metallic materials.

In a further embodiment, the shroud and the impeller are formed from the same material.

In a further embodiment, an interlayer is arranged between the impeller and the shroud.

In a further embodiment, the interlayer is configured to shear as the impeller rotates at a high speed and temperature.

In a further embodiment, the shroud has slots configured to receive the impeller blade, the adhesive is in the slots.

In a further embodiment, the shroud has a partial blade with wedges that mate with the impeller blade, the adhesive at the partial blade wedges.

A method of joining an impeller to a shroud according to an exemplary aspect of the present disclosure includes, among other things, providing an impeller having a plurality of blades, providing a shroud, applying an adhesive between the shroud and the tips of the plurality of blades of the impeller, and assembling the shroud over the impeller.

In a further embodiment, the adhesive is applied to an inner surface of the shroud.

In a further embodiment, the adhesive is applied to tips of the plurality of impeller blades.

In a further embodiment, the method comprises curing the adhesive at a temperature low enough that it does not alter material properties of the impeller or the shroud.

### BRIEF DESCRIPTION OF THE DRAWINGS

FIG. 1 schematically illustrates a refrigerant system.

FIG. 2 schematically illustrates an example refrigerant compressor.

FIG. 3 illustrates an example impeller for a compressor.

FIG. 4 illustrates an example impeller shroud.

FIG. 5 illustrates an example impeller and shroud assembly.

FIG. 6 illustrates an example impeller and shroud assembly.

FIG. 7A illustrates a portion of an example compressor assembly.

FIG. 7B illustrates a portion of an example compressor assembly.

FIG. 7C illustrates a portion of an example compressor assembly.

### DETAILED DESCRIPTION

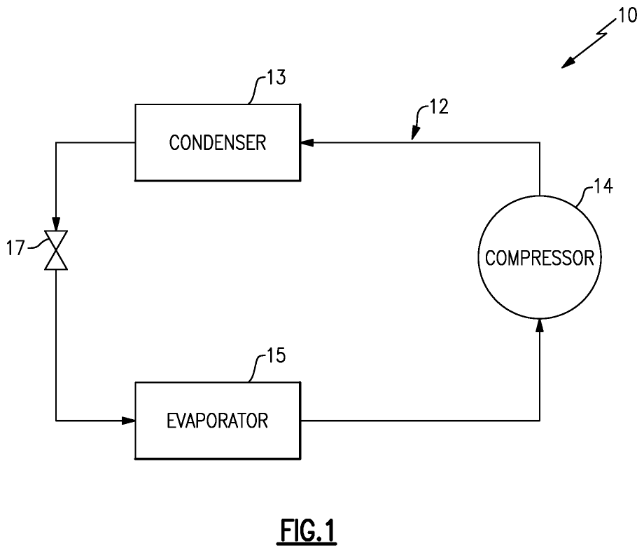

FIG. 1 illustrates a refrigerant system 10. The refrigerant system 10 includes a main refrigerant loop, or circuit, 12 in communication with a compressor 14, a condenser 13, an evaporator 15, and an expansion device 17. This refrigerant system 10 may be used in a chiller, for example. In that example, a cooling tower may be in fluid communication with the condenser 13. While a particular example of the refrigerant system 10 is shown, this application extends to other refrigerant system configurations, including configurations that do not include a chiller. For instance, the main refrigerant loop 12 can include an economizer downstream of the condenser 13 and upstream of the expansion device 17.

FIG. 2 schematically illustrates an example refrigerant compressor 14 according to this disclosure. The refrigerant compressor 14 includes a housing 20 within which an electric motor 16 is arranged. The housing 20 is schematically depicted and may comprise one or more pieces. The electric motor 16 rotationally drives an impeller 18 via a rotor shaft 22 about an axis X to compress refrigerant. The rotor shaft 22 may comprise one or more pieces. The illustrated refrigerant compressor 14 is a centrifugal compressor, meaning, among other things, that the impeller 18 is configured to direct fluid away from the axis of rotation (e.g., the axis X of the shaft 22). In particular, the impeller 18 has an outlet 28 radially outward of an inlet 24, with the outlet 28 axially spaced downstream of the inlet 24. The compressed refrigerant then exits the compressor 14 via an outlet volute 32. While reference herein is made to a refrigerant compressor 14, this disclosure is not limited to any one particular working fluid, and extends to systems configured for other fluids such as air, water, etc.

In this example, the impeller 18 is a shrouded impeller. That is, a shroud 30 encases the impeller 18. The shroud 30 is permanently attached to the impeller 18 and rotates together with the shaft 22. The shroud 30 and impeller 18 need to stay connected under varying forces, such as centrifugal force and thermal expansion differences between the shroud 30 and the impeller 18.

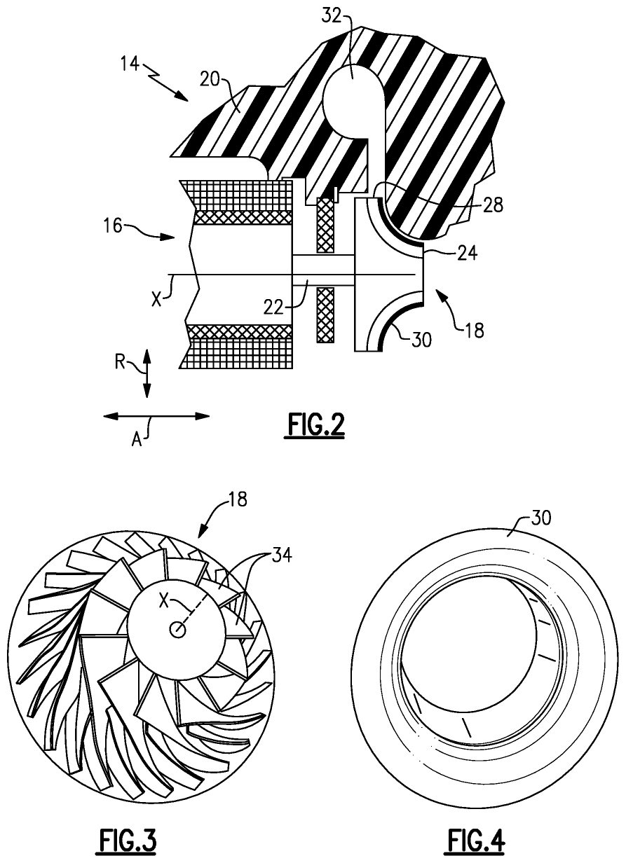

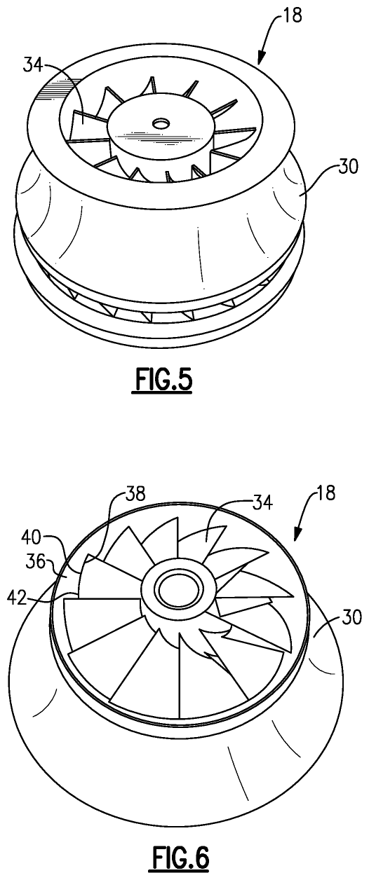

FIG. 3 illustrates an example impeller 18. The impeller 18 has a plurality of blades 34 arranged circumferentially about the axis X. The blades 34 direct the refrigerant radially outward between the inlet 24 and the outlet 28 as the refrigerant is compressed. FIG. 4 illustrates an example shroud 30. The shroud 30 fits over the impeller 18 and contacts the blades 34. The shroud 30 and the impeller 18 may be metallic components, for example. The shroud 30 and the impeller 18 may be the same material, or may be different materials. FIG. 5 illustrates an example impeller 18 with a shroud 30. The impeller 18 is arranged within the shroud 30, and is secured to the shroud 30, such that both the impeller 18 and the shroud 30 are configured to rotate together about the shaft 22.

Compressors may achieve higher efficiency by having zero clearance between the shroud and the impeller. Some known compressors join the shroud 30 and impeller 18 by brazing or welding in which filler material is used to join the shroud and the impeller. Such processes require high temperature operation to melt the filler materials, post material treatment to recover lost material strength by the high temperature, and tooling for the operation. The high temperature needed for welding or brazing can be difficult to control, and can change the microstructure of the base materials. These processes can thus limit productivity of the parts and lead to high manufacturing costs. Further, it can be difficult to control the surface finish near the welded or brazed area due to overflow of the welding or brazing material.

FIG. 6 illustrates another view of the impeller 18 and shroud 30. The disclosed shroud 30 and impeller 18 are joined by an adhesive 42. Using an adhesive 42 without brazing or welding provides a more economical manufacturing method. The adhesive does not require high temperature, which minimizes adverse effects on the base metal mechanical properties and reduces post-joining processes. The shroud 30 has an inner surface 36, and the blades 34 each have tips 38. The tips 38 provide a surface 40 for joining to the inner surface 36 of the shroud 30. The adhesive 42 is arranged between the surfaces 36, 40.

During compressor operation, the adhesive 42 between the shroud 30 and the impeller 18 is required to connect the two parts at all times. This includes under forces such as centrifugal force, thermal expansion differences between the shroud 30 and the impeller 18, transferred torques, and pressure variation along the main flow and secondary flow paths. Most adhesives have lower strength and higher thermal expansion coefficients compared to the metallic impeller and shroud. The material selection and component arrangement may help the adhesive 42 maintain this connection under the different stresses.

In some examples, an interlayer is arranged between the impeller 18 and the shroud 30. The interlayer may be formed from a material having a high ductility. The interlayer may be applied between the impeller 18 and the shroud 30 to help prevent adhesive fracture. As the impeller 18 rotates at high speed and temperature, the stresses shear the interlayer to facilitate the deformation differences between the shroud 30 and the impeller 18. This arrangement may help keep stresses in the adhesive 42 low.

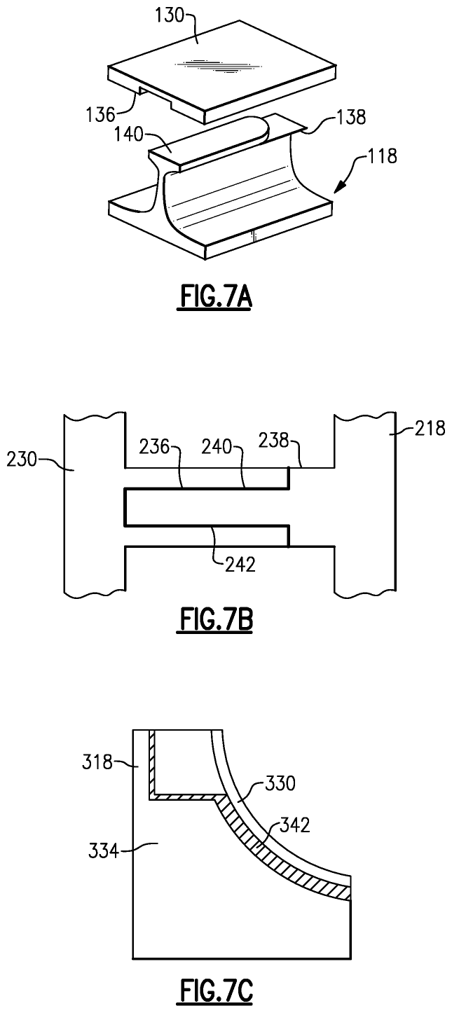

In some examples, the joining surfaces 36, 40 of the shroud 30 and impeller 18 have a special geometry designed for the adhesive 42 to ensure the integrity of the assembly. Although many adhesives have lower strength and higher thermal expansion coefficient than the metal shroud 30 and impeller 18, this geometry is designed to accommodate the adhesive. FIGS. 7A-7C show example geometries of the surfaces 36, 40. To the extent not otherwise described or shown, the components of FIGS. 7A-7C correspond to the compressor 14 of FIGS. 2-6, with like parts having reference numerals preappended with a “1.” Each of these examples increases the area between the joining surfaces. These examples may further reduce the stresses in the adhesive at the joint. In FIG. 7A, the shroud 130 has a slot in the surface 136 that mates with a protrusion 140 on the tips 138 of the impeller blades. In FIG. 7B, the shroud 230 has a partial blade with wedges that mate with the impeller blade 234, and the adhesive 342 is arranged between the shroud 230 and the impeller blade 234 at the partial blade wedges. In FIG. 7C, the adhesive 342 is arranged between a curved surface of the blade 334 and the shroud 330.

In the present example compressor 14, the shroud 30 and impeller 18 materials are selected and designed so that stresses within the joining area are in compression state or low tensile state, to help minimize adhesive fracture. The radial displacement for the impeller 18 and the shroud 30 is inversely proportional to the specific stiffness. The specific stiffness is a ratio of Young's modulus to density. That is, Uᵣ ∝ρ/E, where Uᵣ is the radial displacement, ρ is the density, and E is the Young's modulus. Thus, a shroud 30 with lower specific stiffness than the impeller 18 can reduce tension in the adhesive. The part thermal expansion is proportional to the thermal expansion coefficient. At certain applications, the shroud and impeller thermal expansions can be mismatched to adjust the adhesive stress states.

A method of joining an impeller 18 to a shroud 30 includes applying an adhesive 42 between the shroud 30 and the impeller 18. The adhesive 42 may be applied to an inner surface 36 of the shroud 30 and/or to the tips 38 of impeller blades 34. The adhesive 42 is selected to cure at a relatively low heat. That is, the adhesive 42 cures at a heat lower than that required for welding or brazing. The adhesive 42 may cure at a heat that is low enough that it does not alter the material properties of the impeller 18 and the shroud 30. This method may simplify the manufacturing process by not requiring brazing or welding or subsequent material treatment to counteract the effects of the heat of brazing or welding. This method further may not require the use of fasteners, such as bolts to secure the shroud 30 to the impeller 18. In some examples, the method does not require any post material treatment.

It should be understood that terms such as “axial” and “radial” are used above with reference to the normal operational attitude of a compressor. Further, these terms have been used herein for purposes of explanation, and should not be considered otherwise limiting. Terms such “generally,” “about,” and “substantially” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A refrigerant compressor, comprising:
an impeller configured to rotate about an axis, the impeller having a plurality of blades; and
a shroud secured to the impeller with an adhesive at tips of the plurality of blades.

2. The refrigerant compressor as recited in claim 1, wherein the adhesive cures at a low temperature.

3. The refrigerant compressor as recited in claim 1, wherein the impeller and shroud are secured to one another without the use of welding or brazing.

4. The refrigerant compressor as recited in claim 1, wherein the adhesive permanently secures the shroud to the impeller.

5. The refrigerant compressor as recited in claim 1, wherein the impeller and the shroud are configured to rotate together on a shaft.

6. The refrigerant compressor as recited in claim 5, wherein a motor drives the impeller via the shaft.

7. The refrigerant compressor as recited in claim 6, wherein the impeller, shroud, and motor are arranged in a housing.

8. The refrigerant compressor as recited in claim 1, wherein the shroud is formed from a shroud material having a lower specific stiffness than an impeller material.

9. The refrigerant compressor as recited in claim 1, wherein the shroud is formed from a shroud material that has a first coefficient of thermal expansion and the impeller is formed from an impeller material that has a second coefficient of thermal expansion, the second coefficient of thermal expansion is different from the first coefficient of thermal expansion.

10. The refrigerant compressor as recited in claim 9, wherein the adhesive has a third coefficient of thermal expansion that is higher than the first and second coefficients of thermal expansion.

11. The refrigerant compressor as recited in claim 1, wherein the shroud and the impeller are both formed from metallic materials.

12. The refrigerant compressor as recited in claim 1, wherein the shroud and the impeller are formed from the same material.

13. The refrigerant compressor as recited in claim 1, wherein an interlayer is arranged between the impeller and the shroud.

14. The refrigerant compressor as recited in claim 13, wherein the interlayer is configured to shear as the impeller rotates at a high speed and temperature.

15. The refrigerant compressor as recited in claim 1, wherein the shroud has slots configured to receive the impeller blade, the adhesive is in the slots.

16. The refrigerant compressor as recited in claim 1, wherein the shroud has a partial blade with wedges that mate with the impeller blade, the adhesive at the partial blade wedges.

17. A method of joining an impeller to a shroud, comprising:
providing an impeller having a plurality of blades;
providing a shroud;
applying an adhesive between the shroud and tips of the plurality of blades of the impeller; and
assembling the shroud over the impeller.

18. The method of claim 17, wherein the adhesive is applied to an inner surface of the shroud.

19. The method of claim 17, wherein the adhesive is applied to tips of the plurality of impeller blades.

20. The method of claim 17, comprising curing the adhesive at a temperature low enough that it does not alter material properties of the impeller or the shroud.
